(19) United States
(12) Patent Application Publication
(10) Pub. No.: US 2008/0312885 A1
(43) Pub. Date: Dec. 18, 2008

(54) Hybrid method for simulation optimization

(75) Inventors: Tianjiao Chu, Pittsburgh, PA (US); Victor M. Sheftel, Pittsburgh, PA (US); Jeffrey K. Bennett, Pittsburgh, PA (US); David A. Evans, Pittsburgh, PA (US)

Correspondence Address: JONES DAY, 222 E.41ST STREET, NEW YORK, NY, 10017, US

(73) Assignee: JustSystems Evans Research, Inc.

(21) Appl. No.: 11/811,820

(22) Filed: Jun. 12, 2007

(51) Int. Cl. G06F 17/10

(52) U.S. Cl. 703/2

(57) ABSTRACT

A computer-implemented method of solving a system optimization problem having a plurality of parameters of unknown value is comprised of randomly generating sets of values for unknown parameters within an the optimization problem. A population of original candidate solutions is generated by applying an algorithm for deterministic optimization to each of the sets of values. The population of solutions is ranked. Additional candidate solutions are iteratively generated from at least certain of the solutions in the population. The validity of the additional candidate solutions is checked, and the valid additional candidate solutions are added to the population of solutions. The population of solutions is re-ranked and at least one solution from the population of solutions is output when a predetermined criterion is met whereby the values for the parameters in the output solution may be used for controlling a system.

### BACKGROUND

The present disclosure is directed to techniques for solving optimization problems and, more particularly, to simulation optimization.

For many complex systems with uncertain parameters, it is often difficult, or even impossible, to formulate the optimization problem in analytic form. For example, the objective function could be a complex dynamic system whose output can be accessed only through a simulator. Or the objective function is the expectation or a quantile of a nonlinear function of random parameters with complicated joint distributions. Simulation optimization is a relatively new approach for solving optimization problems for such systems having uncertain parameters or unknown functional forms (Andradóttir 1998).

The basic concept behind the simulation optimization approach is to use simulation to estimate the objective function of the optimization problem. Following that simple principle, various simulation optimization techniques have been proposed since the 1990s. These techniques differ in several key aspects. Some algorithms use simulation to approximate the objective function directly (e.g., the sample path algorithm), while others use simulation to estimate the values of the objective function for given values of the decision variables (e.g., the OptQuest product). Some algorithms search in the space of the decision variables globally (e.g., the Stochastic Model Reference Adaptive Search), while others do the search locally (e.g., the OptQuest product). A short introduction is given by Ólafsson and Kim (2002). For an updated survey of the field, see Fu, Glover, and April (2005).

The OptQuest product is one of the few commercially available simulation algorithms. It consists of two steps. In the first step, a set of candidate solution vectors to the optimization problem is generated systematically, and then scored by evaluating the objective function values of these solutions by simulation. The second step is an iterative procedure. In each iteration, four new candidate solutions are generated by taking linear combinations of two of the best among the solutions found so far, then scored and added to the set of found solutions. A few other optional techniques are also employed to improve the efficiency of the search step. For a detailed explanation of the OptQuest product, see Laguna (1997).

The algorithm used in the OptQuest product is a general purpose algorithm with a broad range of applications. A distinctive feature of this algorithm is that it does not require any detailed information about the objective function. However, this feature could also be a weakness when detailed information about the objective function is available. In particular, when the optimization problem contains a large number of decision variables, the performance of the OptQuest product can be limited by the quality of the solutions found in its first step. In addition, the second step has the undesirable feature of confining the solution in the space spanned by the solutions found in the first step.

The Sample Path algorithm approximates the solution of a simulation optimization problem with a solution of deterministic optimization problem. It is mainly designed for those optimization problems where the objective function is E[H(X, Θ)], that is, the mean of a function H(X, Θ) of decision variables X and uncertain parameters Θ). Let Θ₁, . . . , Θₙ be n realizations of Θ. The sample path algorithm tries to optimize the analytically formed deterministic objective function

$${\overline{H}}_{n} = \frac{1}{n} {\sum }_{i = 1}^{n} H ( X , {Θ}_{i} ) ,$$

then uses the solution as the solution to the problem of optimizing E[H(X, Θ)]. For a justification of the sample path algorithm, see Robinson (1996).

The most distinct feature of the sample path algorithm is the transforming of the problem of optimizing a model with uncertain parameters to a deterministic optimization problem, which allows the algorithm to employ the powerful techniques of deterministic optimization. However, when the objective function of the original problem is not the mean, but a quantile of a function of uncertain parameters, the sample path algorithm no longer applies. Also, because the constraints of the optimization problem often contain uncertain parameters, the optimization of H̅ₙ could be too complicated to be feasible. For example, if one of the constraints is that 90% of probability H(X, Θ) must be finite, the corresponding constraint in the deterministic optimization problem involves n binary variables, each of which is a function of a number of uncertain parameters and the decision variables.

The Model Reference Adaptive Search algorithm (SMRAS) is the latest among the three algorithms, first proposed in Hu, Fu, and Marcus (2005). Like the sample path algorithm, it is also designed to solve optimization problems where the objective function is E[H(X, Θ)], that is, the mean of a function H(X, Θ) of decision variables X and uncertain parameters Θ. The main concept of the SMRAS algorithm is a model based search over the space of the solutions. More precisely, the SMRAS algorithm assigns first a parametric distribution f₀ to the space Ω of the solutions. Solutions are generated randomly from the space Ω according to f₀, and scored by estimating their objective function values using the simulation method. The scores of these solutions are used to update the original distribution f₀, so that eventually, after m iterations, the resulting distribution fₘ will assign most mass to a small region around the optimal solution. The solution generated according to fₘ is likely close to being optimal.

The SMRAS algorithm performs the search over the solution space via a series of updated parametric distributions. This makes its search global, not confined to the small region around the best solutions found so far. However, like the sample path algorithm, it does not apply to simulation optimization problems where the objective functions are quantiles of functions of uncertain parameters. Moreover, although Hu, Fu, and Marcus (2005) report success of applying SMRAS to some simple problems, it is not clear how well it generalizes to real world problems with thousands of decision variables.

### SUMMARY

A computer-implemented method of, and apparatus for, solving a system optimization problem having a plurality of parameters of unknown value is disclosed. The method comprises randomly generating sets of values for unknown parameters within an optimization problem, generating a population of original candidate solutions by applying an algorithm for deterministic optimization to each of the sets of values of the unknown parameters, testing the validity of the solutions returned by the deterministic optimization algorithm, and ranking the population of solutions. Valid solutions are those that satisfy all problem constraints, which can include a required minimum stability, described below. Additional candidate solutions are iteratively generated by randomly combining portions of a subset of the solutions in the population. The validity of the additional candidate solutions is checked. The valid additional candidate solutions are added to the population of solutions, which is then re-ranked. At least one solution is output from the population of solutions whereby the values for the parameters in the output solution may be used for controlling a system.

The stability of each solution returned by the deterministic, optimization algorithm may be evaluated by running N simulations (e.g., N=500) with randomly chosen (from predefined probability distributions) values of the model uncertain parameters, and evaluating the feasibility of this solution under each combination of the uncertain parameters. The stability of the solution is equal to the ratio of the number of feasible combinations of the parameters (i.e., combinations not breaking feasibility of the solution) to the total number of simulations N.

We refer to the disclosed method as a Hybrid, Simulation, Optimization (HSO) algorithm because this algorithm combines deterministic optimization tools with simulation and search. This algorithm fills the gap between deterministic optimization tools and traditional simulation optimization algorithms and improves the cost and performance of optimizing complex systems with uncertain parameters. In particular, by taking advantage of the information about the objective function, the hybrid algorithm is designed to handle problems with a large number of decision variables and a large number of constraints involving uncertain parameters.

The algorithm is easy to implement, and compares favorably with other simulation optimization algorithms for the problems of project modeling where 1) we have detailed knowledge about the objective function and/or 2) the objective function could be a quantile of some function (e.g., we want to minimize the 80^{th} percentile of the total project time, FTE), and/or 3) the optimization problem involves thousands or more decision variables. The algorithm is highly modular, as both the deterministic optimization routine used in the first stage or step and the search routine used in the second stage or step can be replaced by any comparable standard routines. Thus, the method of the present disclosure can be implemented such that the algorithm could select automatically suitable routines based on the nature of the problem to solve (e.g., Simplex method for LP problems, interior-point method for NLP problems, branch-and-bound method for MIP, etc.)

### BRIEF DESCRIPTION OF THE DRAWINGS

For the present disclosure to be readily practiced and easily understood, the disclosure will now be described, for purposes of illustration and not limitation, in conjunction with preferred embodiments in which:

FIG. 1 is an example of a chart illustrating objective function vs. stability;

FIG. 2 illustrates a first step or stage according to one embodiment of the disclosed hybrid simulation optimization algorithm;

FIG. 3 illustrates a second step or stage according to one embodiment of the disclosed hybrid simulation optimization algorithm; and

FIG. 4 illustrates hardware on which the methods disclosed herein may be practiced.

### DESCRIPTION

The HSO algorithm is designed for optimization problems where a mathematical model of the objective function is available, but the values of some parameters in the model are uncertain. To illustrate the application of the HSO algorithm, consider the following very simple example.

Suppose a software company is planning a small software development project. The project has three key aspects: core algorithm programming, GUI development, and documentation. There are 10 people available to work on the project. The manager would like to optimally allocate time for a team of no more than four people, such that the project can be completed on time, at the least cost, and with the highest attainable quality.

Upon opening the HSO program, the manager can input information about the project and about the candidate team members as parameters of the optimization model. The manager knows some of the parameters, and enters their values directly. For example, each person's salary is known as well as their skills on the three key aspects of the project. The minimum skill level required for each of these aspects is also known. Some parameters are uncertain and can be assigned only a probability distribution. For example, the manager is not sure about the exact number of days each person is available, so the manager has to assign a probability distribution to the availability of each person.

For example, the manager assumes that a particular GUI designer will be unavailable for 5 days (at 5% probability), 6 days (at 30% probability), 7 days (at 55% probability), or 8 days (at 10% probability). Similarly, the manager specifies the estimated effort required for each part of the project with a probability distribution. For instance, the core algorithm programming might take anywhere from 40 to 50 Full Time Equivalent (FTE) days for a qualified person.

The manager also specifies the decision variables. In this case, there are 10*3=30 decision variables; these are the number of days (if any) each person spends on each part of the project. Next, the manager chooses an objective function. Because the manager would like to have low cost and high quality, the manager could use the cost of the project divided by quality as the objective function to be minimized by the HSO program. The quality of the project might be defined as, for example, the total time spent by qualified people on the project divided by the minimal time required for the project. She also needs to specify a number of constraints: e.g., days spent on all parts of the project by each person cannot exceed the person's available time, etc. Finally, the manager specifies the minimal solution stability constraint; say, 85%. That is, the manager wants to be at least 85% certain that the project will be finished by a given date, and will cost no more than the available budget, if the manager adopts the solution produced by the HSO program and allocates resources according to that solution.

With the model completely specified, the manager can now start the optimization run. First, the HSO program will generate a simulated value for each of the uncertain parameters. For example, the HSO program may pick six as the number of days the GUI designer is unavailable for the project, 42 as the number of FTE days needed for core algorithm programming, etc. With all the uncertain parameters assigned simulated values, the original mathematical optimization model now becomes much simpler to solve. The HSO program will call a deterministic optimization routine to find an optimal solution to this simpler model. The solution to the simpler model, of course, may or may not be a valid solution for the original model, so the HSO program will run a simulation to evaluate it. If the solution passes the test, i.e., its stability is above the minimal requirement of 85%, it will be added to a pool of candidate solutions maintained by the HSO program.

The HSO program executes the above procedure a number of times to collect the initial pool of candidate solutions. Then the HSO program will try to improve on these solutions by executing a search procedure based on genetic algorithms. The manager can monitor the search results and stop the HSO program any time the manager is satisfied with the solutions found so far. Alternatively, the manager could simply let the program run until a predefined criterion is satisfied.

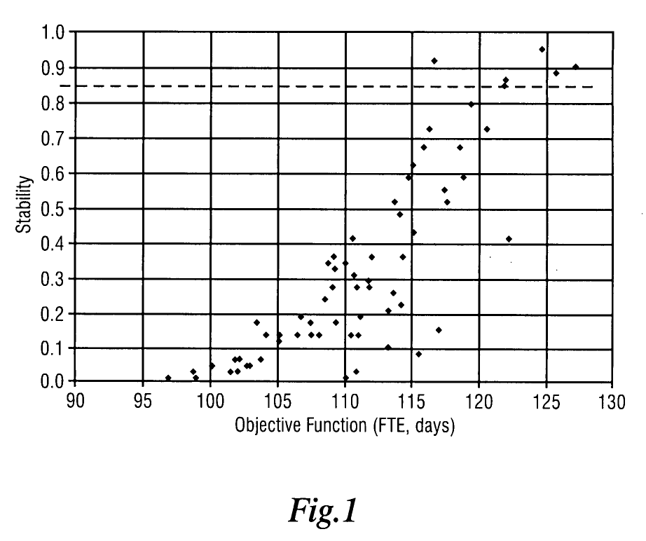

In the end, the HSO program will produce a list of candidate solutions satisfying the minimal stability constraint. In FIG. 1, these solutions are displayed in a plot, where the Y axis represents stability, and the X axis represents the expectation of the objective function value. The solution with the lowest expected objective function value is the optimal solution returned by the HSO program, but other solutions with higher stability and higher expected objective function values may be also of interest in case the manager needs a solution that ensures a higher probability of completing the project. The graph of FIG. 1 shows a threshold stability value of 0.85.

Those of ordinary skill in the art will recognize that the HSO program may be used in any number of different situations dealing with optimization under uncertain conditions. Examples include supply chain optimization, production planning, investment portfolio optimization, factory layout, equipment replacement decisions, among others. The HSO program provides concrete solutions with respect to how to allocate assets of various kinds, such as equipment, manpower, financial resources, among others.

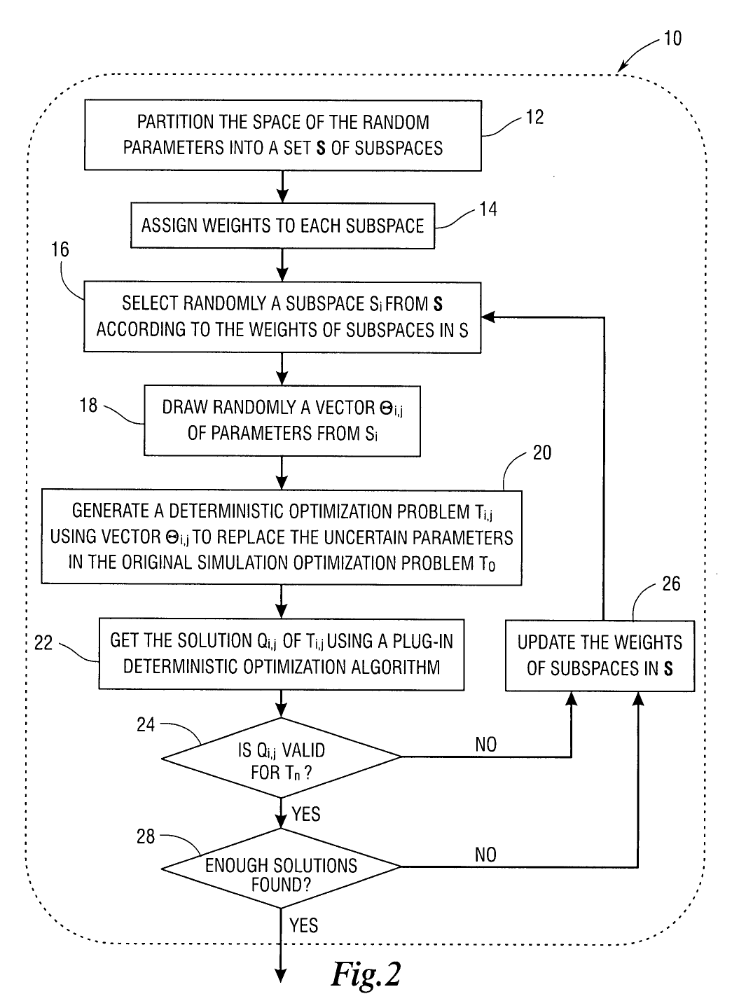

In FIG. 2, the first step 10 of the hybrid, simulation, optimization algorithm may be viewed as the generation of a population of promising original candidate solutions. The first step 10 is described in detail below, but may generally be viewed as comprised of the following steps. First, we partition the space of the uncertain parameters V into equally probable subspaces (according to the joint distribution of V), and assign uniform weights to all the subspaces in steps 12 and 14, respectively. The phrases “uncertain parameters” or “unknown parameters” refer to parameters having uncertain or unknown values. A set of vectors {vᵢ} is drawn from the parameter space such that the probability of a vector being drawn from a given subspace is proportional to the weight of that subspace as shown in steps 16 and 18. In this manner a set of values for the unknown parameters is generated.

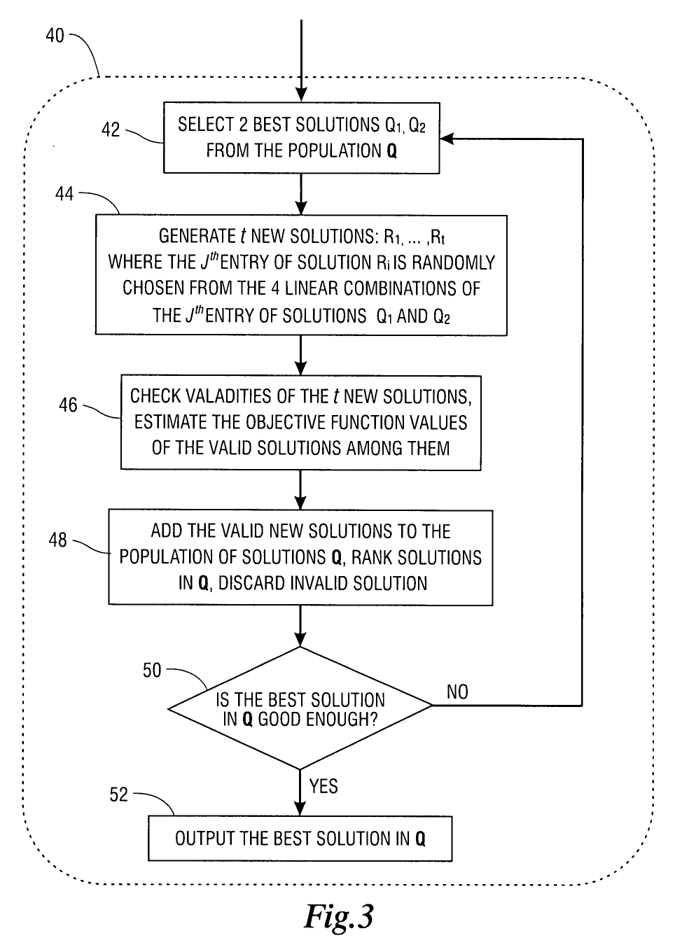

For each vᵢ (i.e., for each set of randomly generated values), we apply a suitable deterministic optimization algorithm to find a vector xᵢ such that X=xᵢ optimizes h(X, vᵢ) as shown by steps 20 and 22. A simulation method may be used to evaluate how good xᵢ is as a solution to O(X) as shown by step 24. If the deterministic algorithm fails to find a valid xᵢ, or if xᵢ is not a good solution for O(X) as determined at decision step 24, the invalid xᵢ may be discarded and the weight of the subspaces where vᵢ was drawn will be down weighted as shown by step 26. After a number of acceptable original candidate solutions are found as determined by the decision step 28, then the hybrid simulation optimization algorithm will continue to the second step 40 illustrated in FIG. 3. As stated above, when the first step 10 of the disclosed hybrid simulation optimization algorithm is completed, a population of ranked, original, candidate solutions is available for the second step 40. The ranking may be based on the value of the objective function vs. some stability criteria, e.g., how good is the value of the objective function vs. how likely is that value going to be achieved.

The second step 40, illustrated in FIG. 3, is a search step to improve the population of solutions by searching in the solution space for better solutions. The search step 40 of the hybrid simulation optimization algorithm uses a search procedure based partly on genetic algorithms that enables a more thorough search of the parameter space. In steps 42 and 44 a group of the highest ranked solutions from the population are selected and randomly weighted averages of components of the solutions are computed to generate additional candidate solutions.

At step 46 the validity of the additional candidate solutions is checked, and for valid additional candidate solutions, the objective function value is estimated. The valid additional candidate solutions are added to the population of solutions and the invalid additional candidate solutions may be discarded as shown in step 48. The population of solutions is then re-ranked. At decision step 50, a determination is made if a best solution meets a predetermined criteria and, if yes, outputting the best solution at 52 whereby the values for the parameters in the output solution may be used for controlling a system and, if no (or if additional solutions are desired), repeating the process by returning to step 42.

Returning to FIG. 1, FIG. 1 is an example of a chart illustrating one type of output of the method of the present disclosure. FIG. 1 is a chart of stability vs. objective function. The reader will understand that each point on the chart represents a solution to a complex problem, such as scheduling a complex construction project. Each solution is a set of values for each parameter in the problem. The stability of each feasible deterministic solution may be evaluated by running N simulations (e.g., N=500) with fixed values of the decision variables belonging to this solution and, with randomly chosen (from predefined probability distributions) values of the uncertain parameters, evaluating the feasibility of this solution under each combination of the uncertain parameters. The stability of the solution is equal to the ratio of the number of feasible combinations of the parameters (i.e., combinations not breaking feasibility of the solution) to the total number of simulations N, and in this case represents the likelihood of a solution being successful.

The objective function in this example represents the number of days the project will take. For example, there are two possible solutions that will take 110 days. However, one solution is almost guaranteed to be unsuccessful (stability close to 0) while the other solution has a somewhat greater chance of success. If success rate is very important, the solution at 125 days having a stability factor of close to 1 would be a good choice. Conversely, if a lower success rate is acceptable, a solution that is achieved in the fewest days and having at least a minimum required stability factor would be a good choice. It is thus seen that the output of the presently disclosed method is a set of solutions to a complex problem, with each solution accompanied by its objective function value an stability. From the solution set, a solution may be chosen that becomes the basis for assigning assets (equipment, people, money, etc.)

The process outlined in FIGS. 2 and 3 will now be described in more detail. Before applying the algorithm of FIGS. 2 and 3, the following information should be available:

1. Information about the parameters:

1.1) The joint distribution of random parameters V={V₁, V₂, . . . , Vₘ}, where the m random parameters are ordered according to their importance.

1.1.1) If all random parameters are jointly independent, information about the marginal distribution of each random parameter is sufficient

1.2) Values of fixed parameters Θ={θ₁, θ₂, . . . , θₙ}.

2) The objective function O(X, Θ) to be maximized must be either the expectation or a quantile of an analytic form function h(X, V, Θ) of decision variables X, random parameters V, and fixed parameters Θ. Generally speaking, the objective function cannot be the variance of an analytic form function, unless the mean of that analytic form function is also an analytic form function. That is, we have either:

O(X, Θ)=E[h(X, V, Θ)], or O(X, Θ; q)=inf{z: F⁻¹(z; X, Θ)≦q}, where F is the cumulative distribution function of h(X, V, Θ).

3) Constraint functions:

3.1) Ranges of decision variables X={X₁, X₂, . . . , Xₖ}

3.2) Constraints depending only on decision variables X and fixed parameters Θ.

3.3) Constraints that are expectations of functions of decision variables X, random parameters V, and fixed parameters Θ.

The first step 10 of the hybrid simulation optimization algorithm—generating a population of n promising original candidate solutions, where n may be defined after the start of the algorithm. If n is not set by the user, user should specify parameter tₜ, the total time the user would like the program to run, and parameter nₛ, the number of searched to be conducted in the second stage of the hybrid algorithm.

The following parameters are user specified:

n: size of initial population of solutions. n≧3.
s: number of partitions of the space of the parameters. s<n, default to be around n/2.
c: number of partitions in the space of an independent random parameter, default to 2
m′: number of independent random parameters whose spaces are going to be partitioned into c parts, 0≦m′≦m.
r: number of random parameters to drawn in each simulation estimation of objective function and constraints. Default to 500.
t: number of new candidate solutions generated from the best two solutions in the population. 4^{k}>t≧2, default to 4.

Steps 12 and 14

Partition the space of the random parameters into s subspaces, so that the probability of each subspace is 1/s.

Assign weight wᵢ=1 to the ith subspace.

1.1) If all random parameters are independent, we can set S=c^{m′}(c−1)^{m-m′}, then partition the range of each random parameter V into c or c−1 intervals so that the marginal distribution of V will assign equal probability to each subspace. For example, if the space of V is divided into c subspaces, the first subspace is (−∞, q₁], the ith subspace is: (qᵢ₋₁, qᵢ] for i=2, . . . , c−1, and the last subspace is (q_{c-1}, ∞), with qᵢ being the i/c quantile of V.

Steps 18, 20, 22, 24, 26, and 28

Initialize p=0.

2.1) Generate the vector v₁ by taking the mode of each random parameter, then run the simulation.

2.1.1) Optimization:
2.1.1.1) Set the random parameters to v₁, feed v₁, Θ, and the constraints 3.1) and 3.2) to a deterministic optimization algorithm to search for values of x to maximize the function h(x, v₁, Θ), and set the returned vector xᵢ as the value of the decision variables.
2.1.1.2) Record the computer time of the optimization, let it be to.

2.1.2) Simulation:
2.1.2.1) Generate r random vectors from the space of the random parameters,
2.1.2.2) Estimate the constraints 3.3) and the objective function o=E[h(x₁, V, Θ)] or o=inf{z: F⁻¹(z; x₁, Θ)≦q}.

2.1.2.3) If no constraint is violated, record the objective function oᵢ and solution x₁, set p=1.
2.1.2.4) Record the computer time of the optimization, let it be tₛ.
2.1.3) (Optional) If n is specified by the user, but the user specifies the total time tₜ the user would like the program to run, and the number of searches nₛ to be done in the second stage of the hybrid algorithm, then set n to be (tₜ−nₛtₛ)/(tₒ+tₛ).

While only p solutions are found, and p<n:

2.2) If n−p≧Σᵢwᵢ, for i=1, . . . s, draw a value randomly from the ith partition with probability wᵢ, where wᵢ is the weight of the ith partition. Otherwise, select n-p subspaces randomly by drawing without replacement from the finite population of s weighted subspaces. This is equivalent to a series of multinomial draws, with the multinomial distribution updated after each draw: Remove the category selected in the last draw and renormalize the probabilities for the remaining categories.

2.3) For each selected subspace:
2.3.1) Generate a vector vᵢ from the selected subspace.
2.3.2) Set the random parameters to vᵢ, feed vᵢ, Θ, and the constraints 3.1) and 3.2) to a deterministic optimization algorithm to search for values of x to maximize (or minimize, according to the problem specification), the function h(x, vᵢ, Θ), and set the returned vector xᵢ as the value of the decision variables.

2.3.3) Run simulation
2.3.3.1) Generate r random vectors from the space of the random parameters, (from the entire space, not a single subspace.)
2.3.3.2) Estimate the constraints 3.3) and the objective function oᵢ=E[h(xᵢ, V, Θ)] or o=inf{z: F⁻¹(z; xᵢ, Θ)≦q}.

2.3.3.3) If at least one constraint is violated, decrease by half the weight of the subspaces from which vᵢ is generated. A more sophisticated penalty function can be used to set the weight of the partition. For example, the penalty may depend on the number of constraints that are violated, and/or how severe the constraints are violated. Otherwise, record the objective function oᵢ and solution xᵢ, and set p=p+1.

The second step 40 of the hybrid simulation optimization algorithm—searching for better solutions.

The search procedure of the hybrid algorithm is inspired by the genetic algorithm. The second step is repeated until a predefined number of iterations is reached (the number of iterations may default to 100) and/or the best solution meets a predetermined criterion.

Steps 42, 44, 46, 48, 50, and 52

1. (Optional) Train a support vector machine to determine through classification whether a candidate set of decision variables satisfies the constraints 3.3.

2. Find the 2 highest ranked solutions x₁ and x₂ (i.e., solutions that satisfy all the constraints and have the highest objective function values.) (step 42)

3. Generate t additional candidate solutions such that the i^{th} dimension of the k^{th} new solution is: λ_{ικ}x₁ᵢ+(1−λ_{ικ})x₂ᵢ, where xᵢⱼ is the i^{th} dimension of xⱼ:, and λ_{ικ} is a randomly generated real number with uniform distribution over a small range of real values, including zero. Depending on the nature of problem, rounding and/or other adjustments may be applied to components of these new solutions. (step 44)

Validate the t solutions

4.1) Remove any of these t solutions violating constraints 3.1) and 3.2)

4.2) (Optional) Remove with probability 0.5 any of these t solutions that are predicted by the support vector machine to be likely violating the constraints 3.3). A more sophisticated rejection mechanism may set the probability a solution being removed dependent on how confident we are about the output of the SVM algorithm. (step 46)

5) Run simulation for each of the remaining candidate solutions

5.1) Generate r random vectors from the space of the random parameters,

5.2) Estimate the constraints 3.3) and the objective function oᵢ=E[O(xᵢ, V, Θ)].

5.3) If all constraints are satisfied, record the objective function oᵢ and add solution xᵢ to the population. (Steps 46 and 48)

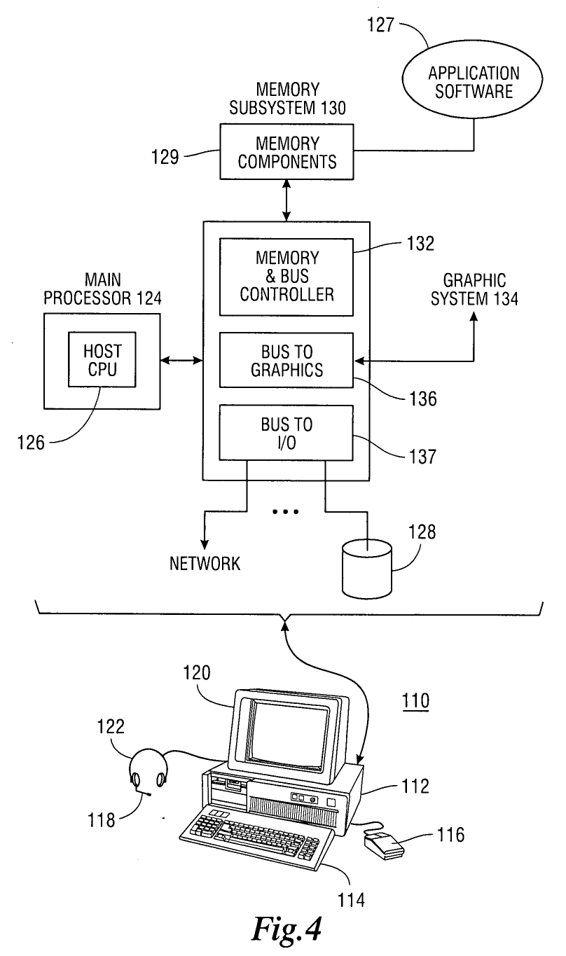

FIG. 4 is a block diagram of hardware 110 which may be used to implement the various embodiments of the method of the present invention. The hardware 110 may be a personal computer system comprised of a computer 112 having as input devices keyboard 114, mouse 116, and microphone 118. Output devices such as a monitor 120 and speakers 122 may also be provided. The reader will recognize that other types of input and output devices may be provided and that the present invention is not limited by the particular hardware configuration.

Residing within computer 112 is a main processor 124 which is comprised of a host central processing unit 126 (CPU). Software applications 127, such as the method of the present invention, may be loaded from, for example, disk 128 (or other device), into main memory 129 from which the software application 127 may be run on the host CPU 126. The main processor 124 operates in conjunction with a memory subsystem 130. The memory subsystem 130 is comprised of the main memory 129, which may be comprised of a number of memory components, and a memory and bus controller 132 which operates to control access to the main memory 129. The main memory 129 and controller 132 may be in communication with a graphics system 134 through a bus 136. Other buses may exist, such as a PCI bus 137, which interfaces to I/O devices or storage devices, such as disk 128 or a CDROM, or to provide network access.

While the present invention has been described in conjunction with preferred embodiments thereof, those of ordinary skill in the art will recognize that many modifications and variations are possible. For example, the present invention may be implemented in connection with a variety of different hardware configurations. Various deterministic optimization techniques may be used, and various methods of producing additional candidate solutions, among others, may be used and still fall within the scope of the present invention. Such modifications and variations fall within the scope of the present invention which is limited only by the following claims.

What is claimed is:

1. A computer-implemented method of solving a system optimization problem involving the utilization of assets, said problem having a plurality of parameters of unknown value, said method comprising:
randomly generating sets of values for unknown parameters within an optimization problem;
generating a population of original candidate solutions by applying an algorithm for deterministic optimization to each of said sets of values;
ranking said population of solutions;
iteratively generating additional candidate solutions from at least certain of the solutions in said population;
checking the validity of the additional candidate solutions;
adding said valid additional candidate solutions to said population of solutions;
ranking said population of solutions;
outputting at least one solution from said population of solutions; and
assigning assets based on said at least one solution.

2. The method of claim 1 wherein said randomly generating sets of values comprises:
partitioning the space of the unknown parameters into a set of S subspaces;
assigning a weight to each subspace;
selecting randomly a subspace Sᵢ from the set of subspaces according to the weights of each subspace; and
selecting randomly a set of parameters from subspace Sᵢ

3. The method of claim 2 additionally comprising checking the validity of each original candidate solution and updating the weights of the subspaces to favor those yielding valid solutions.

4. The method of claim 1 wherein said algorithm for deterministic optimization is selected from the group consisting of Simplex for LP, Integer-point for NLP and Branch-and-Bound for MIP.

5. The method of claim 1 wherein said iteratively generating comprises:
specifying a probability distribution function;
randomly selecting two solutions in said population based on said specified probability distribution function; and
generating additional candidate solutions by taking randomly weighted averages of components of the two selected solutions.

6. The method of claim 1 additionally comprising;
selecting a group of the highest ranked solutions from the population;
comparing said highest ranked solutions to a predetermined criterion, and wherein said outputting is responsive to said comparing.

7. A computer-implemented method of solving a system optimization problem having a plurality of parameters of unknown value, comprising;
assigning weights to parameters within an optimization problem;
randomly generating a set of values for unknown parameters based on said assigned weights;
generating an original candidate solution by applying an algorithm for deterministic optimization to said set of values;
determining if said original candidate is valid, and if valid, adding said original candidate solution to a population of solutions, and if not valid, discarding said original candidate solution and updating said assigned weights;
repeating said randomly generating a set of values, generating an original candidate solution, and determining until said population reaches a predetermined size;
searching the solution space until at least one solution meets a predetermined criteria;
outputting said at least one solution; and
assigning assets based on said at least one solution.

8. The system of claim 7 additionally comprising ranking said population of solutions, and wherein said searching the solution space comprises:
generating additional candidate solutions by applying a genetic algorithm to top ranked solutions;
checking the validity of the additional candidate solutions;
adding said valid additional candidate solutions to said population of solutions; and
re-ranking said population of solutions.

9. A computer-implemented method of solving a system optimization problem having a plurality of parameters of unknown value, comprising;
generating a population of original candidate solutions by using deterministic optimization for a plurality of randomly generated sets of values for unknown parameters within an optimization problem;
ranking said population of solutions;
selecting the two highest ranked solutions;
generating additional candidate solutions by randomly switching parameters between the two highest ranked solutions;
checking the validity of the additional candidate solutions;
adding the valid additional candidate solutions to said population;
re-ranking said population;
determining if a top ranked solution meets a predetermined criteria, if yes, outputting said top ranked solution whereby the values for the parameters in the output solution may be used for controlling a system and, if no, repeating the process beginning with said step of selecting the two highest ranked solutions.

10. The system of claim 9 comprises:
assigning weights to parameters within an optimization problem;
randomly generating a set of values for unknown parameters based on said assigned weights;
generating an original candidate solution by applying an algorithm for deterministic optimization to said set of values; and
determining if said original candidate is valid, and if valid, adding said original candidate solution to the population of solutions, and if not valid, discarding said original candidate solution and updating said assigned weights.
repeating said randomly generating a set of values, generating an original candidate solution, and determining until said population reaches a predetermined size.

11. A computer readable medium carrying a set of instructions which, when executed, perform a method of solving a system optimization problem involving the utilization of assets, said problem having a plurality of parameters of unknown value, said method comprising:
randomly generating sets of values for unknown parameters within an optimization problem;
generating a population of original candidate solutions by applying an algorithm for deterministic optimization to each of said sets of values;
ranking said population of solutions;
iteratively generating additional candidate solutions from at least certain of the solutions in said population;
checking the validity of the additional candidate solutions;
adding said valid additional candidate solutions to said population of solutions;
ranking said population of solutions; and
outputting at least one solution from said population of solutions whereby said at least one solution is used to control the assignment of assets.

12. A computer readable medium carrying a set of instructions which, when executed, perform a method of solving a system optimization problem having a plurality of parameters of unknown value, comprising;
assigning weights to parameters within an optimization problem;
randomly generating a set of values for unknown parameters based on said assigned weights;
generating an original candidate solution by applying an algorithm for deterministic optimization to said set of values;
determining if said original candidate is valid, and if valid, adding said original candidate solution to a population of solutions, and if not valid, discarding said original candidate solution and updating said assigned weights;
repeating said randomly generating a set of values, generating an original candidate solution, and determining until said population reaches a predetermined size;
searching the solution space until at least one solution meets a predetermined criteria;
outputting said at least one solution whereby said at least one solution is used to assign assets.

13. A computer readable medium carrying a set of instructions which, when executed, perform a method of solving a system optimization problem having a plurality of parameters of unknown value, comprising;
generating a population of original candidate solutions by using deterministic optimization for a plurality of randomly generated sets of values for unknown parameters within an optimization problem;
ranking said population of solutions;
selecting the two highest ranked solutions;
generating additional candidate solutions by randomly switching parameters between the two highest ranked solutions;
checking the validity of the additional candidate solutions;
adding the valid additional candidate solutions to said population;
re-ranking said population;
determining if a top ranked solution meets a predetermined criteria, if yes, outputting said top ranked solution whereby the values for the parameters in the output solution may be used for controlling a system and, if no, repeating the process beginning with said step of selecting the two highest ranked solutions.
